(19) United States
(12) Patent Application Publication
(10) Pub. No.: US 2025/0088247 A1
(43) Pub. Date: Mar. 13, 2025

(54) METHOD AND DEVICE USED FOR WIRELESS COMMUNICATION

(71) Applicant: Xiaobo ZHANG, Shanghai (CN)

(72) Inventor: Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/959,693

(22) Filed: Nov. 26, 2024

Related U.S. Application Data
(63) Continuation of application No. PCT/CN2023/096863, filed on May 29, 2023.

(30) Foreign Application Priority Data
May 31, 2022 (CN) 202210608894.7

(51) Int. Cl. H04B 7/06

(52) U.S. Cl. CPC H04B 7/0626; H04B 7/0632; H04B 7/0639

(57) ABSTRACT

The present application provides a method and a device used for wireless communications. A first node receives a first message, the first message is used to determine a first RS resource group and a first frequency-band resource group, the first RS resource group comprises at least one RS resource, and the first frequency-band resource group comprises multiple sub-bands; transmits at least first channel information; wherein the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group. The present application can improve the performance of channel information and has good compatibility.

### CROSS REFERENCE TO RELATED APPLICATIONS

This application is the continuation of the international patent application No.PCT/CN2023/096863, filed on May 29, 2023, and claims the priority benefit of Chinese Patent Application CN202210608894.7, filed on May 31, 2022, the full disclosure of which is incorporated herein by reference.

### BACKGROUND

### Technical Field

The present application relates to methods and devices in wireless communication systems, particularly a scheme and device for Channel Status Information (CSI) in a wireless communication system.

### Related Art

In traditional wireless communications, the UE (User Equipment) reporting may comprise at least one of a variety of auxiliary information, such as CSI (Channel Status Information), Beam Management related auxiliary information, positioning related auxiliary information and so on. CSI comprises at least one of a CRI (CSI-RS Resource Indicator), an RI (Rank Indicator), a PMI (Precoding Matrix Indicator) or a CQI (Channel quality indicator).

The network equipment selects appropriate transmission parameters for the UE according to the UE's reporting, such as a camping cell, an MCS (Modulation and Coding Scheme), a TPMI (Transmitted Precoding Matrix Indicator), a TCI (Transmission Configuration Indication) and other parameters. In addition, the UE's reporting can be used to optimize network parameters such as better cell coverage, switching base stations according to UE location, etc.

In an NR (New Radio) system, a priority of a CSI report is defined, the priority being used to determine whether CPU (CSI Processing Unit) resources are allocated to a corresponding CSI report for updating or whether a corresponding CSI report is dropped.

### SUMMARY

As the number of antennas increases, the traditional PMI feedback approach introduces a large amount of redundancy overhead, therefore, AI (Artificial Intelligence)-based or ML (Machine Learning)-based CSI compression was projected in NR R (release) 18. In traditional multi-antenna systems, the calculation of CQI is usually conditional on PMI; for example, CQI is calculated based on the assumption that the PMI of UE reporting is adopted by the base station. The applicant has found through researches that traditional CSI reporting supports sub-band-based PMI reporting, and how AI-based or ML-based CSI compression can support similar functions will face challenges.

To address the above problem, the present application provides a solution. It should be noted that while a large number of embodiments of the present application are directed to AI/ML, the present application is also applicable to schemes based on traditional methods such as linear channel reconstruction; in particular, it is considered that specific channel reconstruction algorithms are likely to be non-standardized or self-implemented by hardware equipment vendors. Further, the adoption of a unified UE reporting scheme can reduce implementation complexity or improve performance. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

Where required, the explanation of terms in the present application can refer to specifications of TS37 series and TS38 series of 3GPP (3rd Generation Partner Project).

The present application provides a method in a first node for wireless communications, comprising:
a first receiver, receiving a first message, the first message being used to determine a first RS resource
group and a first frequency-band resource group, the first RS (Reference Signal) resource group comprising at least one RS resource, the first frequency-band resource group comprising multiple sub-bands; and
a first transmitter, transmitting at least first channel information;
herein, the first frequency-band resource group is within a first BWP (bandwidth part), and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

In one embodiment, the above method maintains compatibility with traditional sub-band based CSI feedback.

Specifically, according to one aspect of the present application, the above method is characterized in that frequency-domain resources which any channel information in the at least first channel information is for comprise at least one sub-band in the first frequency-band resource group; a number of channel information comprised in the at least first channel information is related to the frequency-domain location of the multiple sub-bands in the first frequency-band resource group.

In one embodiment, CSI accuracy and radio redundancy are balanced.

Specifically, according to one aspect of the present application, the above method is characterized in that a type of the first channel information is related to the frequency-domain location of the multiple sub-bands in the first frequency-band resource group; the type of the first channel information is either a PMI or a first type, where the first type is non-codebook-based; when the type of the first channel information is a PMI, Q1 is a positive integer less than Q2, or a codebook type of the first channel message is used to determine Q1, and when the type of the first channel information is a first type, Q1 is Q2; Q2 is a positive integer greater than 1 and less than the number of sub-band(s) comprised in the first frequency-band resource.

In one embodiment, the above method simultaneously utilizes the advantages of the first type and a PMI type, improving the feedback accuracy or reducing the radio overhead.

Specifically, according to one aspect of the present application, the above method is characterized in that Q1 is a number of sub-band(s) belonging to the first frequency-band resource group in continuous Q2 sub-bands starting from a first sub-band, and Q2 is a positive integer greater than 1 and less than the number of sub-band(s) comprised in the first frequency-band resource group; the at least first channel information consists of multiple channel information, where the first channel information is any channel information in the multiple channel information, the first sub-band is a sub-band with lowest frequency in the first frequency-domain resource group and not belonging to frequency-domain resources targeted by a first channel information subset, the first channel information subset comprises all channel information satisfying a condition in the multiple channel information, and the condition is that a frequency of frequency-domain resources targeted is lower than a frequency of frequency-domain resources which the first channel information is for.

In one embodiment, the above method reduces the required hardware complexity of the first type, or increases the life cycle of a generator of channel information of the first type.

In one embodiment, the above method improves the accuracy of channel information of the first-type.

Specifically, according to one aspect of the present application, the above method is characterized in comprising:
transmitting a first CQI;
herein, regardless of Q1, the frequency-domain resources which the first CQI is for are a sub-band in the first frequency-band resource group, and the first CQI is associated with the first channel information.

In one embodiment, the above method can more accurately reflect the channel quality.

In one embodiment, the above method has good compatibility.

In one embodiment, the above method avoids using the same channel reconstructor for the first node and the second node, which improves flexibility and reduces hardware complexity.

In one embodiment, the above method avoids using the same channel reconstructor for products from different manufacturers, which improves flexibility.

In one embodiment, the first CQI being associated with the first channel information means that the first CQI and the first channel information are configured by same ReportQuantity.

Specifically, according to one aspect of the present application, the above method is characterized in that the measurement for the first RS resource group is used to generate a first matrix group, a first matrix group being used to generate the first CQI, the first matrix group is only available for the first node, the first matrix group comprises at least one channel matrix, and the first matrix group is associated with the first channel information.

Specifically, according to one aspect of the present application, the above method is characterized in that Q1 is related to at least one of an SCS of the first BWP or a frequency range to which the first frequency-band resource group belongs.

The present application provides a method in a second node for wireless communications, comprising:
transmitting a first message, the first message being used to determine a first RS resource group and a first frequency-band resource group, the first RS resource group comprising at least one RS resource, the first frequency-band resource group comprising multiple sub-bands; and receiving at least first channel information;
herein, the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

The present application provides a second node for wireless communications, comprising:
a second transceiver, transmitting a first message, the first message being used to determine a first RS resource group and a first frequency-band resource group, the first RS resource group comprising at least one RS resource, the first frequency-band resource group comprising multiple sub-bands; and
a second receiver, receiving at least first channel information;
herein, the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

The present application provides a first node for wireless communications, comprising:
a first receiver, receiving a first message, the first message being used to determine a first RS resource group and a first frequency-band resource group, the first RS resource group comprising at least one RS resource, the first frequency-band resource group comprising multiple sub-bands; and
a first transmitter, transmitting at least first channel information;
herein, the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of communications of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of hardware modules of a communication node according to one embodiment of the present application;

FIG. 5 illustrates a flowchart of transmission between a first node and a second node according to one embodiment of the present application;

FIGS. 6a, 6b and 6c respectively illustrate schematic diagrams of frequency-domain resources targeted by three different channel information;

FIG. 7 illustrates a schematic diagram of an artificial intelligence processing system according to one embodiment of the present application;

FIG. 8 illustrates a schematic diagram of a transmission of first channel information according to one embodiment of the present application;

FIG. 9 illustrates a schematic diagram of a first encoder according to one embodiment of the present application;

FIG. 10 illustrates a schematic diagram of a first function according to one embodiment of the present application;

FIG. 11 illustrates a schematic diagram of a decoding layer group according to one embodiment of the present application;

FIG. 12 illustrates a structure block diagram of a processor in a first node according to one embodiment of the present application;

FIG. 13 illustrates a structure block diagram of a processor in a second node according to one embodiment of the present application;

FIG. 14 illustrates a flowchart of a measurement in a first RS resource group according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of communications of a first node according to one embodiment of the present application, as shown in FIG. 1.

A first node 100 receives a first message in step 101, the first message is used to determine a first RS resource group and a first frequency-band resource group, the first RS resource group comprises at least one RS resource, the first frequency-band resource group comprises multiple sub-bands; transmits at least first channel information in step 102.

In embodiment 1, the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

In one embodiment, a channel information for a frequency-domain resource comprises: the channel information indicates parameters of a channel on the frequency-domain resource.

In one embodiment, a channel information for a frequency-domain resource comprises: the channel information is calculated based on an assumption that a radio signal is transmitted on the frequency-domain resource.

In one embodiment, the first message is used to configure the at least first channel information.

In one embodiment, the first message is a higher-layer signaling.

In one embodiment, the first message comprises an RRC signaling.

In one embodiment, the first message comprises a CSI-ReportConfig IE (Information Element).

In one embodiment, the first channel information is used to determine phase, amplitude, or coefficient between at least two antenna ports.

In one embodiment, the first channel information is used to determine at least one eigenvector.

In one embodiment, the first channel information is used to determine at least one eigenvalue.

In one embodiment, the first channel information is used to determine at least one pre-coding matrix.

In one embodiment, for any sub-band in Q1 sub-band(s), the first channel information is used to determine a precoding matrix.

In one embodiment, Q1 is not greater than 18.

In one embodiment, the first RS resource group comprises at least one downlink RS resource used for channel measurement.

In one subembodiment of the above embodiment, the first RS resource group comprises at least one downlink RS resource used for interference measurement.

In one embodiment, a measurement for the first RS resource group comprises a channel measurement performed in the at least one downlink RS resource used for channel measurement.

In one embodiment, a measurement for the first RS resource group comprises an interference measurement performed in the at least one downlink RS resource used for interference measurement.

In one embodiment, any RS resource in the first RS resource group is a downlink RS resource.

In one embodiment, any RS resource in the first RS resource group is a Channel state information Reference signal (CSI-RS) resource.

In one embodiment, the first message is used to determine the frequency-domain resource targeted by the first channel information.

In one embodiment, the first RS resource group is indicated by resourcesForChannelMeasurement, csi-IM-ResourcesForInterference, or nzp-CSI-RS-ResourcesForInterference in the first message.

In one embodiment, the first frequency-band resource group is indicated by csi-ReportingBand in the first message.

In one embodiment, any sub-band in the first frequency-band resource group comprises at least one Physical Resource Block (PRB).

In one embodiment, except for an outermost sub-band in the first BWP, a number of PRB(s) comprised in all sub-bands in the first frequency-band resource group is P1, P1 being a positive integral multiple of 4.

In one embodiment, P1 is indicated by a higher-layer signaling.

In one embodiment, P1 is related to a number of PRB(s) comprised in the first BWP.

In one embodiment, if the first frequency-band resource group comprises a first one of sub-band(s) in the first BWP, a number of PRB(s) comprised in the first one of sub-band(s) is P1-(Ns mod P1), where Ns is an index of a starting PRB in the first BWP; if the first frequency-band resource group comprises a last one of sub-band(s) in the first BWP, a number of PRB(s) comprised in the last one of sub-band(s) is (Ns+Nw) mod P1 or P1, where Nw is a number of PRB(s) comprised in the first BWP.

In one embodiment, P1 is one of 4, 8, 16, or 32.

In one embodiment, the at least first channel information comprises multiple channel information, and the multiple channel information is transmitted on a physical-layer channel.

In one embodiment, the physical-layer channel is a PUSCH (Physical Uplink Shared Channel).

In one embodiment, the physical-layer channel is a PUCCH (Physical Uplink Control Channel).

In one embodiment, the first channel information is any channel information in the multiple channel information.

In one embodiment, the first channel information is one of the multiple channel information, and frequency-domain resources which the first channel information is for comprise a sub-band with lowest frequency in the first frequency-band resource group.

In one embodiment, the first channel information is one of the multiple channel information, and frequency-domain resources which the first channel information is for comprise a sub-band with highest frequency in the first frequency-band resource group.

In one embodiment, the frequency-domain location of the multiple sub-bands in the first frequency-band resource group comprises a number of sub-bands in the multiple sub-bands in the first frequency-band resource group.

In one embodiment, the frequency-domain location of the multiple sub-bands in the first frequency-band resource group comprise a location of the multiple sub-bands in the first frequency-band resource group in the first BWP.

In one embodiment, the frequency-domain location of the multiple sub-bands in the first frequency-band resource group is used to determine the Q1.

### Embodiment 2

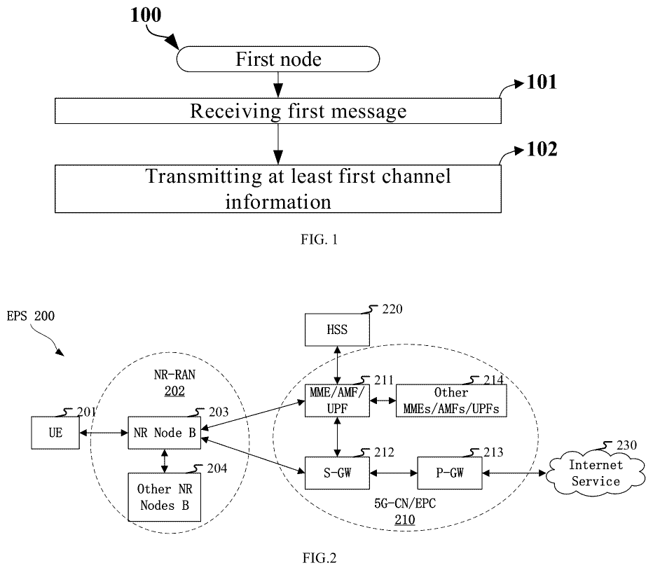

Embodiment 2 illustrates a schematic diagram of a network architecture according to one embodiment of the present application, as shown in FIG. 2. FIG. 2 illustrates the system architecture of 5G NR (New Radio), LTE (Long Term Evolution), and LTE-A (Long Term Evolution Advanced). The 5G NR or LTE network architecture 200 may be called a 5G System/Evolved Packet System (5GS/EPS) 5 or other appropriate terms. The EPS 200 may comprise UE 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application, and the gNB 203 corresponds to the second node in the present application.

In one embodiment, the UE 201 supports generating reports using AI (Artificial Intelligence) or Machine Learning.

In one embodiment, the UE 201 supports using training data to generate a trained model or using the trained data to generate partial parameters in the trained model.

In one embodiment, the UE 201 supports determining at least partial parameters of CNN (Conventional Neural Networks) used for CSI reconstruction through training.

In one embodiment, the UE 201 is a terminal supporting Massive-MIMO.

In one embodiment, the gNB 203 supports a transmission based on Massive-MIMO.

In one embodiment, the gNB 203 supports performing decompression on CSI using AI or deep learning.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the first node and the second node in the present application are respectively the UE 201 and the gNB 203.

### Embodiment 3

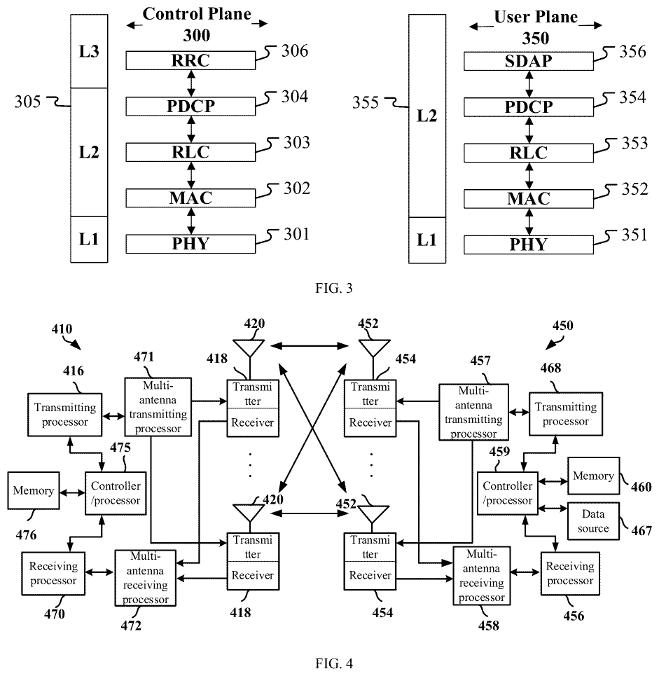

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE or RSU in V2X, vehicle equipment or On-Board Communication Unit) and a second node (gNB, UE or RSU in V2X, vehicle equipment or On-Board Communication Unit), or between two UEs is represented by three layers, which are respectively layer 1, layer 2 and layer 3. The layer 1 (L1) is the lowest layer and performs signal processing functions of various PHY layers. The L1 is called PHY 301 in the present application. The layer 2 (L2) 305 is above the PHY 301, and is in charge of the link between the first node and the second node, and between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes. The PDCP sublayer 304 provides data encryption and integrity protection and provides support for handover of a first node between second nodes. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel. The MAC sublayer 302 is also responsible for allocating between first nodes various radio resources (i.e., resource block) in a cell. The MAC sublayer 302 is also responsible for HARQ operations. In the control plane 300, the RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first node may comprise several higher layers above the L2 305, such as a network layer (i.e., IP layer) terminated at a P-GW of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first reference signal in the present application is generated by the PHY 301.

In one embodiment, the first channel information in the present application is generated by the PHY 301.

In one embodiment, the first channel information in the present application is generated by the MAC sublayer 302.

In one embodiment, the first CQI in the present application is generated by the PHY 301.

In one embodiment, the first message in the present application is generated by the RRC sublayer 306.

In one embodiment, the first message in the present application is generated by the MAC sublayer 302.

### Embodiment 4

Embodiment 4 illustrates a schematic diagram of hardware modules of a communication node according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs channel coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 de-interleaves and channel decodes the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second node 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs channel coding, interleaving, and modulation mapping. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first message, the first message is used to determine a first RS resource group and a first frequency-band resource group, the first RS resource group comprises at least one RS resource, the first frequency-band resource group comprises multiple sub-bands; transmits at least first channel information; herein, the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

In one embodiment, the first communication device 450 comprises at least one processor and at least one memory. a memory that stores a computer readable instruction program. The computer readable instruction program generates an action when executed by at least one processor. The action includes: receiving the first message; transmitting the at least first channel information.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first message, the first message is used to determine a first RS resource group and a first frequency-band resource group, the first RS resource group comprises at least one RS resource, the first frequency-band resource group comprises multiple sub-bands; receives at least first channel information; herein, the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

In one embodiment, the second communication device 410 comprises a memory that stores a computer readable instruction program. The computer readable instruction program generates an action when executed by at least one processor. The action includes: transmitting the first message; receiving the at least first channel information.

In one embodiment, the first communication device 450 corresponds to a first node in the present application.

In one embodiment, the second communication device 410 corresponds to a second node in the present application.

In one embodiment, the first communication device 450 is a UE, and the second communication device 410 is a base station.

In one embodiment, the antenna 452, the receiver 454, the multi-antenna receiving processor 458, and the receiving processor 456 are used for the measurement for the first RS resource group.

In one embodiment, the controller/processor 459 is used for the measurement for the first RS resource group.

In one embodiment, the controller/processor 459 is used to generate the at least first channel information.

In one embodiment, the antenna 452, the transmitter 454, the multi-antenna transmitting processor 457, the transmitting processor 468, and the controller/processor 459 are used to transmit the at least first channel information.

In one embodiment, the antenna 420, the transmitter 418, the multi-antenna transmitting processor 471, and the transmitting processor 416 are used to transmit a reference signal on at least one RS resource in the first RS resource group.

In one embodiment, the controller/processor 475 is used to transmit a reference signal on at least one RS resource in the first RS resource group.

In one embodiment, the antenna 420, the receiver 418, the multi-antenna receiving processor 472, the receiving processor 470 and the controller/processor 475 is used to receive the at least first channel information.

### Embodiment 5

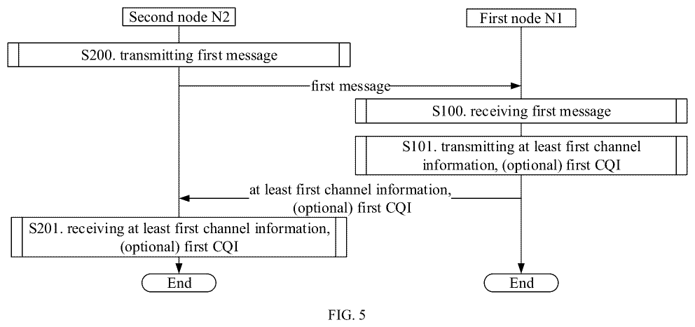

Embodiment 5 illustrates a flowchart of transmission between a first node and a second node, as shown in FIG. 5. First CQI in FIG. 5 is optional.

The first node N1 receives a first message in step S100, and transmits at least first channel information in step S101;
the second node N2 transmits the first message in step S200, and receives the at least first channel information in step S201;

In embodiment 5, the first message is used to determine a first RS resource group and a first frequency-band resource group, the first RS resource group comprises at least one RS resource, the first frequency-band resource group comprises multiple sub-bands; the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

In one embodiment, frequency-domain resources which any channel information in the at least first channel information is for comprise at least one sub-band in the first frequency-band resource group;
a number of channel information comprised in the at least first channel information is related to the frequency-domain location of the multiple sub-bands in the first frequency-band resource group.

In one embodiment, the phrase that a number of channel information comprised in the at least first channel information is related to the frequency-domain location of the multiple sub-bands in the first frequency-band resource group comprises: the frequency-domain location of the multiple sub-bands in the first frequency-band resource group is used to determine a number of channel information comprised in the at least first channel information.

In one embodiment, a method for determining the number of channel information comprised in at least the first channel information comprises: frequency-domain resources which any channel information in the at least first channel information is for is within the first BWP, and there does not exist two channel information whose target frequency-domain resources are completely identical in the at least first channel information.

In one embodiment, a method for determining the number of channel information comprised in at least the first channel information comprises: each sub-band in the first frequency-band resource group belongs to and only belongs to frequency-domain resources targeted by one channel information in the at least first channel information.

In one embodiment, the first BWP comprises L1 frequency-domain sub-resources, L1 being a positive integer greater than 1, and the frequency-domain resources which the first channel information is for belong to one of the L1 frequency-domain sub-resources; the number of channel information comprised in the at least first channel information is a number of frequency-domain sub-resources overlapping with the first frequency-band resource group in frequency domain in the L1 frequency-domain sub-resources.

In one subembodiment of the above embodiment, if the number of channel information comprised in the at least one first channel information is greater than 1, the at least one channel information corresponds one-to-one with frequency-domain sub-resources overlapping with the first frequency-band resource group in frequency domain in the L1 frequency-domain sub-resources.

In one embodiment, a division of the L1 frequency-domain sub-resources is independent of the frequency-domain location of the multiple sub-bands in the first frequency-band resource group.

The above embodiments simplify the division of frequency-domain sub-resources, thus reducing the complexity.

In one embodiment, each channel message in the at least first channel information is non-codebook-based.

In one embodiment, channel information generated based on artificial intelligence or machine learning is non-codebook-based.

In one embodiment, a channel information being non-codebook based comprises: a channel matrix recovered by a receiver of the channel information according to the channel information is not available to a transmitter of the channel information.

In one embodiment, a channel information being non-codebook based comprises: the channel information is used for precoding, and the channel information does not comprise a codebook index.

In one embodiment, the measurement for the first RS resource group is used to generate a first matrix group, a first matrix group being used to generate the first channel information, and the first matrix group comprises at least one channel matrix.

In one embodiment, the first matrix group is only available for the first node.

In one embodiment, the frequency-domain resources which the first channel information is for are fixed.

In one embodiment, a type of the first channel information is related to the frequency-domain location of the multiple sub-bands in the first frequency-band resource group; the type of the first channel information is either a PMI or a first type, where the first type is non-codebook-based; when the type of the first channel information is a PMI, Q1 is a positive integer less than Q2, or a codebook type of the first channel message is used to determine Q1, and when the type of the first channel information is a first type, Q1 is Q2; Q2 is a positive integer greater than 1 and less than the number of sub-band(s) comprised in the first frequency-band resource.

In one subembodiment of the above embodiment, the at least first channel information comprises multiple channel information, and at least one channel information in the multiple channel information is of the first type.

In one embodiment, the multiple channel information is configured by the first message.

The above method combines the first type and a PMI type, which can simplify the complexity of generating channel information of the first type or ensure the performance of the first-type channel information; and is compatible with the existing sub-band based configuration.

In one embodiment, the PMI is a type I codebook index, and when the type of the first channel information is a PMI, Q1 is 1.

In one embodiment, the PMI is a type II codebook index, and when the type of the first channel information is a PMI, Q1 is 1.

In one embodiment, the PMI is based on an enhanced Type II codebook, and the multiple channel information only comprises channel information of PMI type.

In one subembodiment of the above embodiment, when the type of the first channel information is a PMI, Q1 is a difference value obtained by subtracting Q3 from a number of sub-band(s) comprised in the first frequency-band resource group, where Q3 is a product of Q2 and N4, and N4 is a number of channel information of the first type comprised in the multiple channel information.

The above embodiments and sub-embodiments can achieve balance in CSI performance, compatibility, and computational complexity.

In one embodiment, the at least first channel information consists of multiple channel information, and the first channel information is any of the multiple channel information.

In one embodiment, the first message indicates a codebook type of the PMI.

In one embodiment, the first node N1 transmits a first CQI in the step S101, and the first node N2 receives the first CQI in the step S201; herein, regardless of a value of Q1, the frequency-domain resources which the first CQI is for are a sub-band in the first frequency-band resource group, and the first CQI is associated with the first channel information.

In one embodiment, the first CQI being associated with the first channel information refers to: the first CQI and the first channel information are configured by same ReportQuantity.

In one embodiment, the first CQI being associated with the first channel information refers to: the first CQI and the first channel information are configured by the first message.

In one embodiment, the first CQI being associated with the first channel information refers to: the first CQI and the first channel information are both based on a measurement for the first RS resource group.

In one embodiment, the first CQI being associated with the first channel information refers to: the first CQI is conditional on a precoding matrix indicated by the first channel information.

In one embodiment, when the type of the first channel information is a PMI, a calculation of the first CQI is conditional on a precoding matrix indicated by the first channel information; when the type of the first channel information is the first type, a measurement for the first RS resource group is used to generate a first channel matrix, and the first CQI is conditional on the first channel matrix.

In one embodiment, the first channel information is used to recover the first channel matrix.

Under the limitations of the above methods or embodiments, the specific algorithm used to calculate the first CQI is determined by the manufacturer of the first node N1 itself, or implementation related. The following describes a typical but non-restrictive implementation method:

the first node N1 first measures reference signal resources used for channel measurement in the first RS resource group to obtain channel parameter matrix H_{r×t}, where r,t are a number of receiving antennas and a number of antenna port(s) used for transmission respectively; under the condition that a precoding matrix W_{t×l} is adopted, a precoded channel parameter matrix is H_{r×t}·W_{t×l}, where l is a rank or a number of layer(s); an equivalent channel capacity of H_{r×t}·W_{t×l} is calculated adopting criteria such as SINR (Signal Interference Noise Ratio), EESM (Exponential Effective SINR Mapping), or RBIR (Received Block mean mutual Information Ratio), and then the first CQI is determined from the equivalent channel capacity by looking up a table, etc. Generally speaking, the calculation of the equivalent channel capacity requires the first node N1 to estimate noise and interference, if the first RS resource group comprises RS resources used for interference measurement, the first node N1 can use these RS resources to more accurately measure interference or noise. Generally speaking, a direct mapping of the equivalent channel capacity to a CQI value depends on the performance of the receiver or hardware related factors such as modulation methods. The first channel information is used to indicate the pre-coding matrix W_{t×l}.

In one embodiment, when a type of the first channel information is a PMI, the first node N1 and the second node N2 have a same understanding of the precoding matrix W_{t×l}. When a type of the first channel information is the first type, a precoding matrix recovered by the second node N2 according to the first channel information may not be exactly the same as the precoding matrix W_{t×l}.

In one embodiment, the first channel matrix is codebook-based.

In one embodiment, the first channel matrix is a precoding matrix used for calculating CQI based on the assumption that the type of the first channel information is a PMI.

In one embodiment, the precoding matrix used for calculating CQI based on the assumption that the type of the first channel information is a PMI is codebook-based.

Channel information of first type is usually superior to a PMI, for a channel matrix recovered using the first channel information of the first type, the first channel matrix in the above two embodiments is equivalent to a low bound of the precoding performance, and the calculated CQI is also a low bound CQI, which can provide good robustness.

In one embodiment, the second node N2 can adjust the low bound CQI by itself to achieve higher spectral efficiency, and common methods comprise controlling according to ACK rate or outer-loop.

In one embodiment, the first channel matrix comprises at least one eigenvector.

In one embodiment, the first channel matrix comprises at least one eigenvector as well as an eigenvalue corresponding to each eigenvector in the at least one eigenvector.

In one embodiment, each element in the first channel matrix is a channel impulse response between a transmitting antenna port and a receiving antenna.

In one embodiment, each element in the first channel matrix is a channel impulse response on an RB (resource block) or sub-band between a transmitting antenna port and a receiving antenna.

Typically, when the type of the first channel information is the first type, the first channel information is generated based on artificial intelligence methods.

Typically, when the type of the first channel information is the first type, a first encoder is used to generate the first channel information, and the first encoder is obtained based on training.

In one embodiment, the measurement for the first RS resource group is used to generate a first matrix group, a first matrix group being used to generate the first CQI, the first matrix group is only available for the first node N1, the first matrix group comprises at least one channel matrix, and the first matrix group is associated with the first channel information.

The above method allows the first node N1 and the second node N2 to use different training models, which increases the freedom degree for hardware manufacturers.

In one embodiment, Q1 is related to at least one a Subcarrier spacing (SCS) of the first BWP or a frequency range to which the first frequency-band resource group belongs.

In one embodiment, Q1 decreases as the SCS of the first BWP increases.

In one embodiment, a total bandwidth occupied by the Q1 sub-band(s) varies with the frequency range to which the first frequency-band resource group belongs.

In one embodiment, when a frequency range to which the first frequency-band resource group belongs is frequency Range 1, a total bandwidth of the Q1 sub-band(s) is a first bandwidth, when a frequency range to which the first frequency-band resource group belongs is frequency Range 2, a total bandwidth of the Q1 sub-band(s) is a second bandwidth; the second bandwidth is greater than the first bandwidth.

### Embodiment 6a

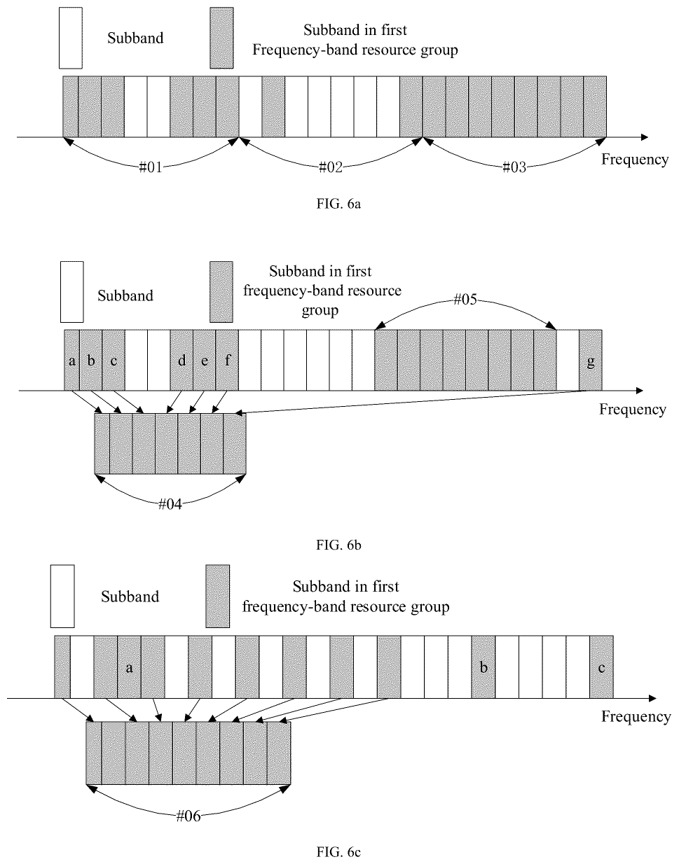

Embodiment 6a illustrates a schematic diagram of frequency-domain resources targeted by channel information according to one embodiment of the present application, as shown in FIG. 6a. In FIG. 6a, the blank square represents a sub-band, and the gray-filled square represents a sub-band in a first frequency-band resource group.

In Embodiment 6a, bidirectional arrows #01, #02, and #03 respectively indicate frequency-domain resources targeted by three channel information in the at least first channel information. According to a frequency-domain location of multiple sub-bands in the first frequency-band resource group, the frequency-domain resources targeted by the three channel information respectively comprise 6 sub-bands in the first frequency-band resource group (a number of PRB(s) comprised in a sub-band with lowest frequency is small), 1 sub-band, and 8 sub-bands.

In Embodiment 6a, for any of the three channel information, a number (i.e. 6, 1, or 8) of sub-band(s) belonging to the first frequency-band resource group in the frequency-domain resources targeted is a number of sub-band(s) belonging to the first frequency-band resource group in continuous Q2 sub-bands starting from a first sub-band, where Q2 is a positive integer greater than 1 and less than the number of sub-bands comprised in the first frequency-band resource group; the first sub-band is a sub-band with lowest frequency in the first frequency-domain resource group and not belonging to frequency-domain resources targeted by a first channel information subset, the first channel information subset comprises all channel information satisfying a condition in the multiple channel information, and the condition is that a frequency of frequency-domain resources targeted is lower than a frequency of frequency-domain resources which the first channel information is for.

In embodiment 6a, the frequency-domain resources targeted by the three channel information are fixed and do not vary with the frequency-domain location of multiple sub-bands in the first frequency-band resource group. Therefore, for channel information based on artificial intelligence or machine learning, the corresponding encoders and decoders are relatively stable and have a long lifecycle, reducing the complexity increase incurred by retraining.

### Embodiment 6b

Embodiment 6b illustrates a schematic diagram of frequency-domain resources targeted by channel information according to one embodiment of the present application, as shown in FIG. 6b. In FIG. 6b, the blank square represents a sub-band, and the gray-filled square represents a sub-band in a first frequency-band resource group.

In embodiment 6b, the bidirectional arrow #05 indicates frequency-domain resources targeted by one channel information in the at least first channel information. According to a a frequency-domain location of multiple sub-bands in the first frequency-band resource group, the frequency-domain resources targeted by the channel information comprise 8 sub-bands in the first frequency-band resource group.

In one embodiment, the first node first searches for sub-bands satisfying predetermined conditions from the first frequency-band resource group, and feeds back channel information of first type for sub-bands satisfying the predetermined conditions, and feeds back channel information of PMI type for sub-bands not satisfying the predetermined conditions.

In one embodiment, the predetermined conditions are related to the training process of channel information of the first type, such as continuous Q2 sub-bands, or equally spaced Q2 sub-bands, etc.

In one embodiment, sub-bands represented by the squares filled with letters a, b, c, . . . g in FIG. 6b form a frequency-domain sub-resource, the frequency-domain sub-resource is a frequency-domain resource targeted by another channel information in the at least first channel information, and the another channel information is based on an enhanced Type II codebook.

In one embodiment, sub-bands represented by the squares filled with letters a, b, c, . . . g in FIG. 6b are respectively frequency-domain resources targeted by 7 channel information in the at least first channel information, and the 7 channel information is based on Type II codebook or Type I codebook.

In one subembodiment of any embodiment of the above two embodiments, the first channel information is the channel information in the at least first channel information, Q1 is Q2, and Q2 is a positive integer (fixed as 8 in FIG. 6b) greater than 1 and less than the number of sub-bands comprised in the first frequency-band resources; the at least first channel information consists of multiple channel information, where the first channel information is channel information of any first type in the multiple channel information, the first sub-band is a sub-band with lowest frequency in the first frequency-domain resource group and not belonging to frequency-domain resources targeted by a first channel information subset, the first channel information subset comprises all channel information satisfying a condition in the multiple channel information, and the condition is that a frequency of frequency-domain resources targeted is lower than a frequency of frequency-domain resources which the first channel information is for; the first channel information subset comprises channel information of all PMI types in the multiple channel information.

In one embodiment, the first sub-band is implicitly indicated by a frequency-domain location of multiple sub-bands in the first frequency-band resource group.

In embodiment 6b, first information can be configured with both codebook-based and non-codebook channel information, thus achieving a balance between performance and complexity.

### Embodiment 6c

Embodiment 6c illustrates a schematic diagram of frequency-domain resources targeted by channel information according to one embodiment of the present application, as shown in FIG. 6c. In FIG. 6c, the blank square represents a sub-band, and the gray-filled square represents a sub-band in a first frequency-band resource group.

In embodiment 6c, the bidirectional arrow #06 indicates frequency-domain resources targeted by one channel information in the at least first channel information. According to a frequency-domain location of multiple sub-bands in the first frequency-band resource group, the frequency-domain resources targeted by the channel information comprise 8 sub-bands in the first frequency-band resource group.

Unlike in FIG. 6b, 8 sub-bands in FIG. 6c are equally spaced.

In one embodiment, sub-bands represented by squares filled with letters a, b, c in FIG. 6c form a frequency-domain sub-resource, the frequency-domain sub-resource is a frequency-domain resource targeted by another channel information in the at least first channel information, and the another channel information is based on an enhanced Type II codebook.

In one embodiment, sub-bands represented by squares filled with letters a, b, and c in FIG. 6c are respectively frequency-domain resources targeted by three channel information in the at least first channel information, and the three channel information is based on Type II codebook or Type I codebook.

### Embodiment 7

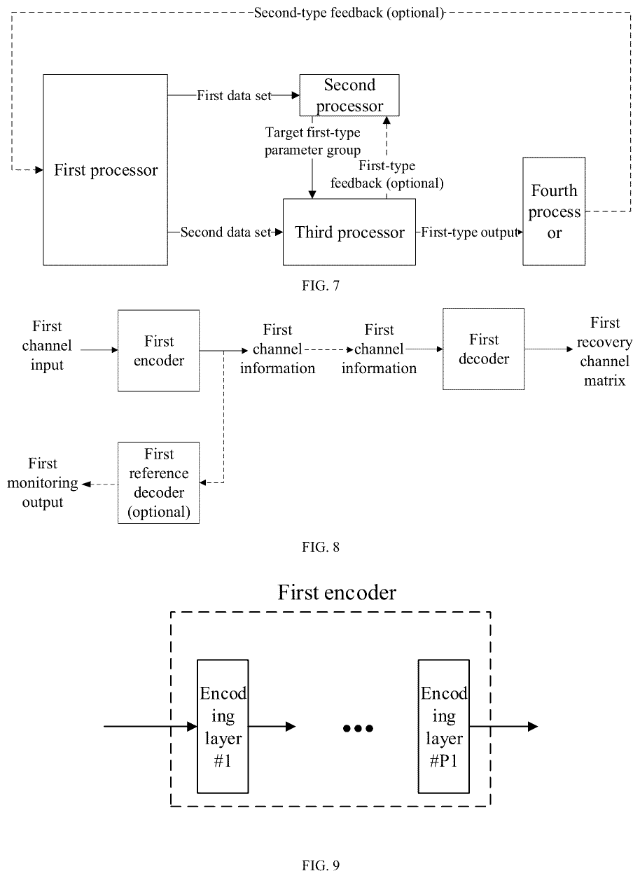

Embodiment 7 illustrates a schematic diagram of an artificial intelligence processing system according to one embodiment of the present application, as shown in FIG. 7. FIG. 7 comprises a first processor, a second processor, a third processor, and a fourth processor.

In Embodiment 7, the first processor transmits a first data set to the second processor, and the second processor generates a target first-type parameter group according to the first dataset, the second processor transmits the generated target first-type parameter group to the third processor, and the third processor processes the second data set using the target first-type parameter group to obtain a first-type output, and then transmits the first-type output to the fourth processor.

In one embodiment, the third processor transmits a first-type feedback to the second processor, and the first-type feedback is used to trigger a recalculation or update of the target first-type parameter group.

In one embodiment, the fourth processor transmits a second-type feedback to the first processor, the second-type feedback is used to generate the first data set or the second data set, or the second-type feedback is used to trigger a transmission of the first data set or second data set.

In one embodiment, the first processor generates the first data set and the second data set according to a measurement for a first radio signal, and the first radio signal comprises a downlink RS.

In one embodiment, the second data set is based on a measurement for the first RS resource group.

In one embodiment, the first processor and the third processor belong to a first node, and the fourth processor belongs to a second node.

In one embodiment, the first-type output comprises the at least first channel information.

In one embodiment, the first-type output comprises channel information belonging to a first type in the at least first channel information.

In one embodiment, the second processor belongs to a first node.

The above embodiment avoids transmitting the first data set to a second node.

In one embodiment, the second processor belongs to a second node.

The above embodiments reduce the complexity of the first node.

In one embodiment, the first data set is training data, the second data set is interference data, the second processor is used to train the model, and the trained model is described by the target first-type parameter group.

Due to the fact that frequency-domain resources occupied by the first data set are often determined, sub-band patterns (or frequency-domain locations) supported by an input of the trained model may also be limited.

In one embodiment, the third processor constructs a model according to the target first-type parameter group, and then inputs the second data set into the constructed model to obtain the first-type output, which is then transmitted to the fourth processor.

In one subembodiment of the above embodiment, the third processor comprises a first encoder in the present application, the first encoder is described by the target first-type parameter group, and a generation of the first-type output is executed by the first encoder.

In one embodiment, the third processor calculates an error between the first-type output and actual data to determine the performance of the trained model; the actual data is data received after the second data set and transmitted by the first processor.

The above embodiments are particularly suitable for prediction-related reporting.

In one embodiment, the third processor recovers a reference data set according to the first-type output, and an error between the reference data set and the second data set is used to generate the first-type feedback.

The recovery of the reference data set usually adopts an inverse operation similar to the target first-type parameter group, and the above embodiments are particularly suitable for CSI compression-related reporting.

In one embodiment, the first-type feedback is used to reflect the performance of the trained model; when the performance of the trained model cannot meet requirements, the second processing opportunity recalculates the target first-type parameter group.

In one subembodiment of the above embodiment, the third processor comprises a first reference decoder in the present application, and the first reference decoder is described by the target first-type parameter group. An input of the first reference decoder comprises the first-type output, and an output of the first reference decoder comprises the reference data set.

Typically, when the error is too large or is not updated for too long, the performance of the trained model is considered unsatisfactory.

In one embodiment, the third processor belongs to the second node, and the first node reports the target first-type parameter group to the second node.

### Embodiment 8

Embodiment 8 illustrates a flowchart of transmission of first channel information according to one embodiment of the present application, as shown in FIG. 8. In FIG. 8, a first reference decoder is optional.

In Embodiment 8, a first encoder and a first decoder belong to a first node and a second node respectively; herein, the first encoder belongs to a first receiver, and the first decoder belongs to a second receiver.

The first receiver generates the at least first channel information using a first encoder; herein, an input of the first encoder comprises a first channel input, and the first encoder is obtained through training; the first channel input is obtained according to a measurement for a first RS resource group;
the first node feeds back first channel information (of a first type or non-codebook-based) to the second node through an air interface;
the second receiver generates a first recovery channel matrix using a first decoder; herein, an input of the first decoder comprises the first channel information, and the first decoder is obtained through training.

The first encoder and the first decoder should theoretically be mutually inverse to ensure that the first channel input is the same as the first recovery channel matrix.

In one embodiment, due to factors such as implementation complexity, radio overhead, or delay, the first encoder and the first decoder in embodiment 8 cannot ensure complete cancellation, therefore, the first channel input and the first recovery channel matrix cannot be guaranteed to be exactly the same, resulting in the traditional CQI calculation method no longer being applicable (i.e. it is unable to find a pre-coding matrix that both parties understand the same to calculate CQI).

In one embodiment, the first channel input is a channel parameter matrix, or a matrix consists of at least one eigenvector.

In one embodiment, the first channel input comprises the first channel matrix.

In one embodiment, the first channel input comprises the first matrix group.

In the above embodiments, the estimate of the first CQI may be too optimistic.

In one embodiment, the first channel matrix is a precoding matrix used for calculating CQI based on an assumption that the type of the first channel information is a PMI.

In the above embodiments, the specific implementation methods are implemented by hardware device manufacturers themselves, for example, selecting a precoding vector or precoding matrix with the largest common cosine similarity to the first channel input from the candidate codebook as a first channel matrix, or selecting a precoding vector or a precoding matrix with the smallest NMSE to the first channel input from the candidate codebook as a first channel matrix; a typical candidate codebook is related to a number of layer(s) in the first channel matrix, and a candidate codebook adopted by the NR system refer to clause 5.2.2.2 of TS38.214.

In one embodiment, the first receiver further comprises a first reference decoder, an input of the first reference decoder comprises the first channel information, and an output of the first reference decoder comprises a first monitoring output.

In one embodiment, the first channel matrix is the first monitoring output, and the first reference decoder cannot be considered identical to the first decoder.

In the above embodiments, the first reference decoder and the first decoder may be independently generated or independently maintained, so that although they are both intended to perform an inverse operation of the first encoder, the two may only be approximate.

In one subembodiment of the above embodiment, the first reference decoder is similar to the first decoder, so that the CQI error incurred by the gap between the two is self-adjusted by the second node.

In one embodiment, the first receiver comprises a third processor in embodiment 7.

In one embodiment, the first channel input belongs to a second data set in embodiment 7.

In one embodiment, the training of the first encoder is executed at the first node.

In one embodiment, the training of the first encoder is executed by the second node.

In one embodiment, the first recovery channel matrix is known only to the second node.

In one embodiment, the first recovery channel matrix cannot be considered identical to the first channel matrix.

### Embodiment 9

Embodiment 9 illustrates a schematic diagram of a first encoder according to one embodiment of the present application, as shown in FIG. 9. In FIG. 9, the first encoder comprises P1 encoding layers, namely encoding layers #1, #2, . . . , #P1.

In one embodiment, P1 is 2, that is, the P1 encoding layers comprise encoding layer #1 and encoding layer #2, and the encoding layer #1 and the encoding layer #2 are a convolutional layer and a fully-connected layer respectively; in the convolutional layer, at least one convolutional kernel is used to convolve the first channel input to generate a corresponding feature map, and at least one feature map output by the convolutional layer is reshaped into a vector and input to the fully-connected layer; the fully-connected layer converts the vector into first channel information. For a more detailed description, refer to CNN-related technical literature, e.g., Chao-Kai Wen, Deep Learning for Massive MIMO CSI Feedback, IEEE WIRELESS COMMUNICATIONS LETTERS, VOL. 7, NO. 5, October 2018 and etc.

In one embodiment, P1 is 3, that is, the P1 encoding layers comprise a fully-connected layer, a convolutional layer and a pooling layer.

### Embodiment 10

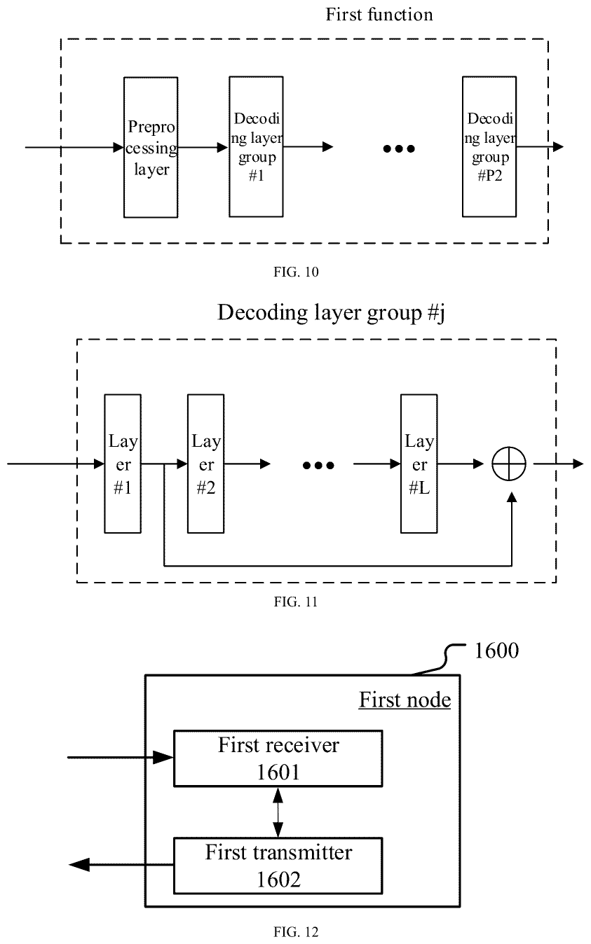

Embodiment 10 illustrates a schematic diagram of a first function according to one embodiment of the present application, as shown in FIG. 10. In FIG. 10, the first function comprises a preprocessing layer and P2 decoding layer groups, namely decoding layer groups #1, #2, . . . , #P2. Each decoding layer group comprises at least one decoding layer.

The structure of the first function is applicable to a first decoder and a first reference decoder in embodiment 8.

In one embodiment, the preprocessing layer is a fully-connected layer that expands a size of the first channel information to a size of the first channel input.

In one embodiment, any two of the P2 decoding layer groups have a same structure, the structure comprises a number of decoding layer(s) comprised, a size of input parameters and a size of output parameters of each decoding layer comprised and etc.

In one embodiment, the second node indicates the structure of P2 and the decoding layer group to the first node, and the first node indicates other parameters of the first function through the second signaling.

In one embodiment, the other parameters comprise at least one of a threshold of an activation function, a size of the convolution kernel, a step-size of the convolution kernel, or the weight between feature maps.

### Embodiment 11

Embodiment 11 illustrates a schematic diagram of a decoding layer group according to one embodiment of the present application, as shown in FIG. 11. In FIG. 11, the decoding layer group #j comprises L layers, that is, layers #1, #2, . . . , #L; the decoding layer group is any of the P2 decoding layer groups.

In one embodiment, L is 4, the first layer of the L layers is an input layer, and the last three layers of the L layers are all convolutional layers, and for a more detailed description, refer to CNN-related technical literature, e.g., Chao-Kai Wen, Deep Learning for Massive MIMO CSI Feedback, IEEE WIRELESS COMMUNICATIONS LETTERS, VOL. 7, NO. 5, October 2018 and etc.

In one embodiment, the L layers comprise at least one convolutional layer and a pooling layer.

### Embodiment 12

Embodiment 12 illustrates a structure block diagram of a processor in a first node according to one embodiment of the present application, as shown in FIG. 12. In FIG. 12, a processor 1600 in a first node comprises a first receiver 1601 and a first transmitter 1602.

The first receiver 1601 receives a first message, the first message is used to determine a first RS resource group and a first frequency-band resource group, the first RS resource group comprises at least one RS resource, and the first frequency-band resource group comprises multiple sub-bands; a first transmitter 1602 transmits at least first channel information;

In embodiment 12, the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

In one embodiment, frequency-domain resources which any channel information in the at least first channel information is for comprise at least one sub-band in the first frequency-band resource group; a number of channel information comprised in the at least first channel information is related to the frequency-domain location of the multiple sub-bands in the first frequency-band resource group.

In one embodiment, a type of the first channel information is related to the frequency-domain location of the multiple sub-bands in the first frequency-band resource group; the type of the first channel information is either a PMI or a first type, where the first type is non-codebook-based; when the type of the first channel information is a PMI, Q1 is a positive integer less than Q2, or a codebook type of the first channel message is used to determine Q1, and when the type of the first channel information is a first type, Q1 is Q2; Q2 is a positive integer greater than 1 and less than the number of sub-band(s) comprised in the first frequency-band resource.

In one embodiment, Q1 is a number of sub-band(s) belonging to the first frequency-band resource group in continuous Q2 sub-bands starting from a first sub-band, and Q2 is a positive integer greater than 1 and less than the number of sub-band(s) comprised in the first frequency-band resource group; the at least first channel information consists of multiple channel information, where the first channel information is any channel information in the multiple channel information, the first sub-band is a sub-band with lowest frequency in the first frequency-domain resource group and not belonging to frequency-domain resources targeted by a first channel information subset, the first channel information subset comprises all channel information satisfying a condition in the multiple channel information, and the condition is that a frequency of frequency-domain resources targeted is lower than a frequency of frequency-domain resources which the first channel information is for.

In one embodiment, the first transmitter 1602 transmits a first CQI;
herein, regardless of Q1, the frequency-domain resources which the first CQI is for are a sub-band in the first frequency-band resource group, and the first CQI is associated with the first channel information.

In one embodiment, the measurement for the first RS resource group is used to generate a first matrix group, a first matrix group being used to generate the first CQI, the first matrix group is only available for the first node, the first matrix group comprises at least one channel matrix, and the first matrix group is associated with the first channel information.

In one embodiment, Q1 is related to at least one of an SCS of the first BWP or a frequency range to which the first frequency-band resource group belongs.

In one embodiment, the first node 1600 is a UE.

In one embodiment, the first transmitter 1602 comprises at least one of the antenna 452, the transmitter/receiver 454, the multi-antenna transmitting processor 457, the transmitting processor 468, the controller/processor 459, the memory 460 or the data source 467 in FIG. 4 of the present application.

In one embodiment, the first transmitter 1602 comprises the antenna 452, the transmitter/receiver 454, the multi-antenna transmitting processor 457, the transmitting processor 468, the controller/processor 459, the memory 460 and the data source 467 in FIG. 4 of the present application.

In one embodiment, the first receiver 1601 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1601 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1601 comprises at least the first three of the antenna 452, the receiver 454, the multi-antenna receiving processor 458, the receiving processor 456, the controller/processor 459, the memory 460 and the data source 467 in FIG. 4 of the present application.

### Embodiment 13

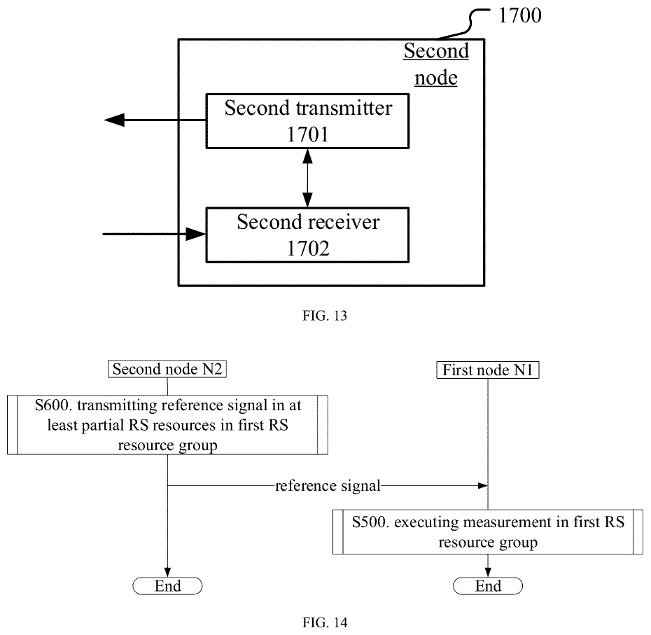

Embodiment 13 illustrates a structure block diagram of a processor in a second node according to one embodiment of the present application, as shown in FIG. 13. In FIG. 13, a processor 1700 in the second node comprises a second transmitter 1701 and a second receiver 1702.

The second transceiver 1701 transmits a first message, the first message is used to determine a first RS resource group and a first frequency-band resource group, the first RS resource group comprises at least one RS resource, the first frequency-band resource group comprises multiple sub-bands; a second receiver 1702 receives at least first channel information;

In embodiment 13, the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

In one embodiment, the second receiver 1702 receives a first CQI;
herein, regardless of Q1, the frequency-domain resources which the first CQI is for are a sub-band in the first frequency-band resource group, and the first CQI is associated with the first channel information.

In one embodiment, frequency-domain resources which any channel information in the at least first channel information is for comprise at least one sub-band in the first frequency-band resource group; a number of channel information comprised in the at least first channel information is related to the frequency-domain location of the multiple sub-bands in the first frequency-band resource group.

In one embodiment, a type of the first channel information is related to the frequency-domain location of the multiple sub-bands in the first frequency-band resource group; the type of the first channel information is either a PMI or a first type, where the first type is non-codebook-based; when the type of the first channel information is a PMI, Q1 is a positive integer less than Q2, or a codebook type of the first channel message is used to determine Q1, and when the type of the first channel information is a first type, Q1 is Q2; Q2 is a positive integer greater than 1 and less than the number of sub-band(s) comprised in the first frequency-band resource.

In one embodiment, Q1 is a number of sub-band(s) belonging to the first frequency-band resource group in continuous Q2 sub-bands starting from a first sub-band, and Q2 is a positive integer greater than 1 and less than the number of sub-band(s) comprised in the first frequency-band resource group; the at least first channel information consists of multiple channel information, where the first channel information is any channel information in the multiple channel information, the first sub-band is a sub-band with lowest frequency in the first frequency-domain resource group and not belonging to frequency-domain resources targeted by a first channel information subset, the first channel information subset comprises all channel information satisfying a condition in the multiple channel information, and the condition is that a frequency of frequency-domain resources targeted is lower than a frequency of frequency-domain resources which the first channel information is for.

In one embodiment, the measurement for the first RS resource group is used to generate a first matrix group, a first matrix group being used to generate the first CQI, the first matrix group is only available for the first node, the first matrix group comprises at least one channel matrix, and the first matrix group is associated with the first channel information.

In one embodiment, Q1 is related to at least one of an SCS of the first BWP or a frequency range to which the first frequency-band resource group belongs.

In one embodiment, the second node 1700 is a base station.

In one embodiment, the second transmitter 1701 comprises the antenna 420, the transmitter 418, the transmitting processor 416 and the controller/processor 475.

In one embodiment, the second transmitter 1701 comprises the antenna 420, the transmitter 418, the multi-antenna transmitting processor 471, the transmitting processor 416 and the controller/processor 475.

In one embodiment, the second transmitter 1701 comprises the antenna 420, the transmitter 418, the transmitting processor 416 and the controller/processor 475.

In one embodiment, the second transmitter 1701 comprises the antenna 420, the transmitter 418, the multi-antenna transmitting processor 471, the transmitting processor 416 and the controller/processor 475.

In one embodiment, the second receiver 1702 comprises the antenna 420, the receiver 418, the multi-antenna receiving processor 472, the receiving processor 470 and the controller/processor 475.

In one embodiment, the second receiver 1702 comprises the controller/processor 475.

### Embodiment 14

Embodiment 14 illustrates a flowchart of performing a measurement in a first RS resource group according to one embodiment of the present application, as shown in FIG. 14.

The first node N1 performs a measurement in a first RS resource group in step S500; the second node N2 transmits a reference signal in at least part of RS resources in a first RS resource group.

In one embodiment, the at least part of RS resources comprise RS resources used for channel measurement.

The specific embodiments of the measurements executed by the first node N1 in the first RS resource group are self-determined by the hardware vendors, and a non-restrictive example is given below:

the first node measures a channel parameter matrix for each PRB, the channel parameter matrix being of Nt rows and Nr columns, where each element is a channel impulse response; the Nt and the Nr are a number of antenna port(s) and a number of receiving antenna(s) in an RS resource, respectively; the first node merges channel parameter matrixes measured on all PRBs within each sub-band to obtain a channel matrix for each sub-band. An input to a first encoder comprises a channel matrix for partial or all sub-bands in the first frequency-band resource group, or, an input to a first encoder comprises an eigenvector of a channel matrix for partial or all sub-bands in the first frequency-band resource group.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first message, the first message being used to determine a first RS (Reference Signal) resource group and a first frequency-band resource group, the first RS resource group comprising at least one RS resource, the first frequency-band resource group comprising multiple sub-bands; and
a first transmitter, transmitting at least first channel information;
wherein the first frequency-band resource group is within a first BWP (Bandwidth part), and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

2. The first node according to claim 1, wherein frequency-domain resources which any channel information in the at least first channel information is for comprise at least one sub-band in the first frequency-band resource group; a number of channel information comprised in the at least first channel information is related to the frequency-domain location of the multiple sub-bands in the first frequency-band resource group.

3. The first node according to claim 1, wherein a type of the first channel information is related to the frequency-domain location of the multiple sub-bands in the first frequency-band resource group; the type of the first channel information is either a PMI (Precoding Matrix Indicator) or a first type, where the first type is non-codebook-based; when the type of the first channel information is a PMI, Q1 is a positive integer less than Q2, or a codebook type of the first channel message is used to determine Q1, and when the type of the first channel information is a first type, Q1 is Q2; Q2 is a positive integer greater than 1 and less than the number of sub-band(s) comprised in the first frequency-band resource.

4. The first node according to claim 1, wherein Q1 is a number of sub-band(s) belonging to the first frequency-band resource group in continuous Q2 sub-bands starting from a first sub-band, and Q2 is a positive integer greater than 1 and less than the number of sub-band(s) comprised in the first frequency-band resource group; the at least first channel information consists of multiple channel information, where the first channel information is any channel information in the multiple channel information, the first sub-band is a sub-band with lowest frequency in the first frequency-domain resource group and not belonging to frequency-domain resources targeted by a first channel information subset, the first channel information subset comprises all channel information satisfying a condition in the multiple channel information, and the condition is that a frequency of frequency-domain resources targeted is lower than a frequency of frequency-domain resources which the first channel information is for.

5. The first node according to claim 1, comprising:
the first transmitter, transmitting first CQI (Channel quality indicator);
wherein regardless of Q1, the frequency-domain resources which the first CQI is for are a sub-band in the first frequency-band resource group, and the first CQI is associated with the first channel information.

6. The first node according to claim 5, wherein the measurement for the first RS resource group is used to generate a first matrix group, a first matrix group being used to generate the first CQI, the first matrix group is only available for the first node, the first matrix group comprises at least one channel matrix, and the first matrix group is associated with the first channel information.

7. The first node according to claim 1, wherein Q1 is related to at least one of an SCS (Subcarrier spacing) of the first BWP or a frequency range to which the first frequency-band resource group belongs.

8. A second node for wireless communications, comprising:
a second transceiver, transmitting a first message, the first message being used to determine a first RS resource group and a first frequency-band resource group, the first RS resource group comprising at least one RS resource, the first frequency-band resource group comprising multiple sub-bands; and
a second receiver, receiving at least first channel information;
wherein the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

9. The second node according to claim 8, comprising:
the second receiver, receiving a first CQI;
wherein regardless of Q1, the frequency-domain resources which the first CQI is for are a sub-band in the first frequency-band resource group, and the first CQI is associated with the first channel information.

10. The second node according to claim 8, wherein frequency-domain resources which any channel information in the at least first channel information is for comprise at least one sub-band in the first frequency-band resource group; a number of channel information comprised in the at least first channel information is related to the frequency-domain location of the multiple sub-bands in the first frequency-band resource group.

11. The second node according to claim 8, wherein a type of the first channel information is related to the frequency-domain location of the multiple sub-bands in the first frequency-band resource group; the type of the first channel information is either a PMI or a first type, where the first type is non-codebook-based; when the type of the first channel information is a PMI, Q1 is a positive integer less than Q2, or a codebook type of the first channel message is used to determine Q1, and when the type of the first channel information is a first type, Q1 is Q2; Q2 is a positive integer greater than 1 and less than the number of sub-band(s) comprised in the first frequency-band resource.

12. The second node according to claim 8, wherein Q1 is a number of sub-band(s) belonging to the first frequency-band resource group in continuous Q2 sub-bands starting from a first sub-band, and Q2 is a positive integer greater than 1 and less than the number of sub-band(s) comprised in the first frequency-band resource group; the at least first channel information consists of multiple channel information, where the first channel information is any channel information in the multiple channel information, the first sub-band is a sub-band with lowest frequency in the first frequency-domain resource group and not belonging to frequency-domain resources targeted by a first channel information subset, the first channel information subset comprises all channel information satisfying a condition in the multiple channel information, and the condition is that a frequency of frequency-domain resources targeted is lower than a frequency of frequency-domain resources which the first channel information is for.

13. The second node according to claim 9, wherein the measurement for the first RS resource group is used to generate a first matrix group, a first matrix group being used to generate the first CQI, the first matrix group is only available for the first node, the first matrix group comprises at least one channel matrix, and the first matrix group is associated with the first channel information.

14. The second node according to claim 8, wherein Q1 is related to at least one of an SCS of the first BWP or a frequency range to which the first frequency-band resource group belongs.

15. A method in a first node for wireless communications, comprising:
receiving a first message, the first message being used to determine a first RS resource group and a first frequency-band resource group, the first RS resource group comprising at least one RS resource, the first frequency-band resource group comprising multiple sub-bands; and
transmitting at least first channel information;
wherein the first frequency-band resource group is within a first BWP, and a measurement for the first RS resource group is used to generate the first channel information; frequency-domain resources which the first channel information is for comprise Q1 sub-band(s) in the first frequency-band resource group, Q1 being a positive integer; Q1 is related to a frequency-domain location of the multiple sub-bands in the first frequency-band resource group.

16. The method in a first node according to claim 15, wherein frequency-domain resources which any channel information in the at least first channel information is for comprise at least one sub-band in the first frequency-band resource group; a number of channel information comprised in the at least first channel information is related to the frequency-domain location of the multiple sub-bands in the first frequency-band resource group.

17. The method in a first node according to claim 15, wherein a type of the first channel information is related to the frequency-domain location of the multiple sub-bands in the first frequency-band resource group; the type of the first channel information is either a PMI or a first type, where the first type is non-codebook-based; when the type of the first channel information is a PMI, Q1 is a positive integer less than Q2, or a codebook type of the first channel message is used to determine Q1, and when the type of the first channel information is a first type, Q1 is Q2; Q2 is a positive integer greater than 1 and less than the number of sub-band(s) comprised in the first frequency-band resource.

18. The method in a first node according to claim 15, wherein Q1 is a number of sub-band(s) belonging to the first frequency-band resource group in continuous Q2 sub-bands starting from a first sub-band, and Q2 is a positive integer greater than 1 and less than the number of sub-band(s) comprised in the first frequency-band resource group; the at least first channel information consists of multiple channel information, where the first channel information is any channel information in the multiple channel information, the first sub-band is a sub-band with lowest frequency in the first frequency-domain resource group and not belonging to frequency-domain resources targeted by a first channel information subset, the first channel information subset comprises all channel information satisfying a condition in the multiple channel information, and the condition is that a frequency of frequency-domain resources targeted is lower than a frequency of frequency-domain resources which the first channel information is for.

19. The method in a first node according to claim 15, comprising:
transmitting a first CQI;
wherein regardless of Q1, the frequency-domain resources which the first CQI is for are a sub-band in the first frequency-band resource group, and the first CQI is associated with the first channel information.

20. The method in a first node according to claim 19, wherein the measurement for the first RS resource group is used to generate a first matrix group, a first matrix group being used to generate the first CQI, the first matrix group is only available for the first node, the first matrix group comprises at least one channel matrix, and the first matrix group is associated with the first channel information;
or,
Q1 is related to at least one of an SCS of the first BWP or a frequency range to which the first frequency-band resource group belongs.
